(19) United States
(12) Patent Application Publication
(10) Pub. No.: US 2025/0363782 A1
(43) Pub. Date: Nov. 27, 2025

(54) SYNTHETIC GENERATION OF TRAINING DATA

(71) Applicant: BASF SE, Ludwigshafen am Rhein (DE)

(72) Inventors: Till EGGERS, Ludwigshafen am Rhein (DE); Christian KLUKAS, Limburgerhof (DE); Christof Stefan JUGEL, Ludwigshafen (DE); Ramon NAVARRA-MESTRE, Limburgerhof (DE)

(21) Appl. No.: 18/874,780

(22) PCT Filed: Jun. 14, 2023
(86) PCT No.: PCT/EP2023/065890

§ 371 Date: Dec. 13, 2024

(30) Foreign Application Priority Data
Jun. 14, 2022 (EP) 22178947.2

(51) Int. Cl. G06V 10/774; G06T 7/00; G06T 11/00; G06V 10/764; G06V 20/70

(52) U.S. Cl. CPC G06V 10/774; G06T 7/0004; G06T 11/00; G06V 10/764; G06V 20/70; G06T 2200/24; G06T 2207/20081; G06T 2207/30108; G06T 2207/30188; G06V 2201/06

(57) ABSTRACT

The present application relates to image processing. A computer-implemented method is provided for generating synthetic training data that is usable for training a data-driven model for analysing a surface image of a physical product that comprises at least one object, the method comprising:
a) providing image data that comprises:
   an object image dataset comprising a plurality of object images of the at least one object, at least one object image being associated with a label usable for annotating a content of the object image; and
   a background image representing a background of a surface image of the physical product;
b) generating a synthetic object image dataset from the object image dataset, wherein the synthetic object image dataset comprises a plurality of synthetic object images of the at least one object, at least one synthetic object image being associated with a label; and
c) generating a plurality of first synthetic training data samples, wherein each first synthetic training data sample is generated by selecting one or more object images from the synthetic object image dataset and by plotting the selected one or more object images at one or more locations on the background image. The computer-implemented method may be used to improve the computer vision technique for the application in the technical field of agriculture and in production environment.

### TECHNICAL FIELD

The present invention generally relates to image processing or computer vision techniques. More specifically, the present invention relates to a computer-implemented method and a synthetic training data generating apparatus for generating synthetic training data that is usable for training a data-driven model for analysing a surface image of a physical product that comprises at least one object, to a computer-implemented method and an image analysing apparatus for analysing a surface image of a physical product, to a method and a system for controlling a production process of a physical product, and to a computer program product.

### BACKGROUND

In the technical field of agriculture, there is steady push to make farming or farming operations more sustainable. Precision farming or agriculture is seen as one of the ways to achieve better sustainability and reducing environmental impact. This relies on the reliable local detection of plant damage in the field. In production environment, monitoring and/or controlling a production process based on images also relies on the reliability of detection of defects and the precise localization of defects.

### SUMMARY OF THE INVENTION

Thus, there may be a need to improve the computer vision techniques such that it is accurate enough to apply the chemical products in suitable amounts. Further, there may be a need to improve computer vision for the application in production environment.

The object of the present invention is solved by the subject-matter of the independent claims, wherein further embodiments are incorporated in the dependent claims. It should be noted that the following described aspects of the invention apply also for the computer-implemented method and the synthetic training data generating apparatus for generating synthetic training data that is usable for training a data-driven model for analysing a surface image of a physical product that comprises at least one object, the computer-implemented method and the image analysing apparatus for analysing a surface image of a physical product, the method and the system for controlling a production process of a physical product, and the computer program product.

In a first aspect of the present disclosure, a computer-implemented method is provided for generating synthetic training data that is usable for training a data-driven model for identifying individual objects in a surface image of a physical product that comprises at least one object, the method comprising:
a) providing (210) image data that comprises:
   an object image dataset comprising a plurality of object images of the at least one object, at least one object image being associated with a label usable for annotating a content of the object image, wherein the label comprises a property that describes the at least one object in the at least one object image and a property value indicative of a damage status of the at least one object in the at least one object image; and
   a background image representing a background of a surface image of the physical product;
b) generating (220) a synthetic object image dataset from the object image dataset, wherein the synthetic object image dataset comprises a plurality of synthetic object images of the at least one object, at least one synthetic object image being associated with a label; and
c) generating (230) a plurality of first synthetic training data samples, wherein each first synthetic training data sample is generated by selecting one or more object images from the synthetic object image dataset and by plotting the selected one or more object images at one or more locations on the background image.

For many use-cases, certain objects need to be identified and located in front of background objects. Examples are identification of insects on leaves, spores or insects in a petri-dish plate, weed in a field, and particles on a substrate in a production process. To identify such objects using deep learning approaches, large training data sets are required. In contrast to the development of classical image processing routines, the main effort (and costs) are not software development costs, but the effort for labelling the data. The actual deep learning algorithms self-adapt to the training data and require much less work for development and tuning. In some cases, classical algorithms are not even able to solve complex image recognition problems. The performance of deep learning approaches depends most on the availability of large training data sets with high quality.

Towards this end, a computer-implemented method and synthetic training data generating apparatus are provided for synthetically generating training data. The synthetic training data can then be used to train models that work on real data. Synthetically producing data can potentially tackle both mentioned challenges—the effort and possibility for flaws in data collection. The algorithms could generate a well distributed dataset with many samples while maintaining a ground truth labelling.

This computer-implemented method comprises several steps. First, image data is provided that comprises images of objects and one or more background images. For example, the user may provide several background images (e.g., empty petri-dish plates, leaves, soil, etc.) and images of objects that are separated from their background, e.g. individual spores, insects or eggs, particles. Using rules and parameters, such as the number of objects in the image, whether objects may overlap or touch, how far or narrow objects should appear, and the like, the actual distribution of the objects in the generated images will be determined. In addition, image augmentation techniques will be employed, to create variations (regarding size, shape, orientation, etc.) of the background and individual classes of object images, so that they reflect the real variability. Also, generative deep learning models, such as Generative Adversarial Networks GAN, Wasserstein GAN, and Non-Adversarial Image Synthesis may be used to further create new but natural looking variants of the input images. After setting the parameters, the actual data set generation can be started. The results, natural looking artificial compositions and automatically generated exact label data can be exported in standard formats, which may be used for various image tasks, such as regression, classification, object detection, and object segmentation. Data-driven models can subsequently be directly be and evaluated or manual fine tuning of data-driven models can be performed on the basis of the generated datasets.

The label data comprises a property that describes the at least one object in the at least one object image and a property value indicative of a damage status of the at least one object in the at least one object image. For example, the property may include one or more of: an object class usable for identifying the at least one object, list of coordinates of the at least one object, a segmentation mask of the at least one object, etc. The property value may include a property value indicative of a plant damage, and/or a property value indicative of a deviation from a standard for an industrial product. The property values can be numeric values (in form of real numbers), such as percentages or absolute values, or the property values can be classifiers (binary classifiers, indicating the presence or absence of a particular property, multi-class classifiers). For example, individual crops may be assessed in the field by a disease prediction algorithm and scored from 0% (healthy) to 100% (dead due to disease).

It is possible to use the synthetic training data to train various types of data-driven models. In some examples, the data-driven model may be a classifier, e.g., to indicate whether a product satisfies a predefined quality criteria. In some examples, the data-driven model may be a regression model, e.g., for determining the number of defects in an image of a product. In some examples, the data-driven model may be a model for object detection and classification, e.g., for detection and classification of defects in an image of a product. In some examples, the data-driven model may be a model for instance segmentation, e.g., for determination of class and/or object to which each pixel in the image belongs.

The data-driven model may be a machine learning algorithm. The machine learning algorithm may be a deep learning algorithm, such as deep neural networks, convolutional deep neural networks, deep belief networks, recurrent neural networks, etc.

In some examples, the data-driven model may be utilized in the technical field of agriculture. In some examples, the data-driven model may be an algorithm for identification of pests (e.g., MYZUS, APHIGO, BEMISA adults, BEMISA Stadia, FRANOC stadia) in field trials. In some examples, the data-driven model may be an algorithm for segmentation of main-leaf-shape of a crop (e.g., tomato, pepper, grapes, apple trees). In some examples, the data-driven model may be an algorithm for identification of weeds.

In some examples, the data-driven model may be a model that is utilized in a production environment. In one example, generation of artificial training datasets to be used for the development of segmentation methods for overlapping objects, in particular cathode active material particles, which in some cases may also include classification of the individual particles. The augmentation of training data based on synthetic and controlled placement of a larger number of previously carefully segmented objects may be useful to reduce the number of images that need to be labelled in time-consuming fashion. In some examples, the data-driven model may be an algorithm for object detection and classification of spores. In some example, the data-driven model may be an algorithm for cell detection. In some examples, the data-driven model may be an algorithm for detection of fluorescence of cells.

An exemplary implementation of the computer-implemented method will be described with respect to the example shown in FIG. 3.

According to an embodiment of the present invention, the at least one object comprises a plurality of objects, at least two objects of which are associated with labels that comprise different property values.

For example, the physical product may be an agricultural field with a plurality of salads therein. At least two salads in the agricultural fields may have different damage statuses caused by e.g., diseases. For example, one salad may be assigned a score 0% (healthy), whereas another salad may be assigned 100% (diseased). The computer-implemented method is not only capable of identifying individual salads in the agricultural fields, but also determining the damage status (or healthy status) of individual salads.

According to an embodiment of the present disclosure, in step b), the synthetic object image dataset is generated using a generative model.

Examples of the generative model may include, but are not limited to, GANs, Variational Autoencoders (VAEs), and Autogressive models such as PixelRNN.

According to an embodiment of the present invention, the generative model comprises a conditional generative adversarial network (cGAN).

Since the current dataset of individual object images is labelled and these labels are required in the workflow, the application of the GAN must maintain and replicate this labelling. It would

be possible to use a regular GAN for the extension of the dataset. However, the labels may get lost. Conditional GANs (cGANs) may be a way to overcome this impediment. This is because that the cGANs allow to include constraints, e.g., property value indicative of a damage status of at least one object. In addition to input images, labels are fed into the network during training. In this way, the network learns to generate images for a corresponding label. After the model is trained, it is able to generate a large dataset of object images per class.

In addition, data from field trials often comes with challenges, notably the small amount and imbalanced distribution of samples. Relying on only the field samples may lead to an overfitted model, resulting in performance losses during test time. The cGANs may be a way to overcome this impediment, as the cGANs can be used to create unbiased and balanced data set, in which undamaged objects (e.g., healthy salads) may be approximately same as damaged objects (unhealthy salads). With the large amount and balanced distribution of synthetic samples, the performance of the data-driven model can be improved.

According to an embodiment of the present disclosure, in step c) the selected one or more object images are plotted on the background image according to a rule derived from one or more surface image samples of the physical product.

In some examples, rules may be specific for each object. Examples of the rules may comprise, but are not limited to, the number of objects in the image, whether objects may overlap or touch, how far or narrow objects should appear, regular arrangement of the objects (e.g., salad) or random arrangement of the object (e.g., weed, cathode active material particles in an image of a battery material, etc.).

In some examples, the rules may be defined by a user. For example, for regular arrangement of the objects, such as salad in a field, the user may define the number of salads in the images, the distance between salads, etc.

In some examples, the rules may be derived from one or more sample images e.g., using a rule-based machine learning algorithm.

According to an embodiment of the present disclosure, step c) further comprises a step of generating a plurality of second synthetic training data samples from the plurality of first synthetic training data samples using an image-to-image translation model, wherein the image-to-image translation model has been trained to generate a synthetic surface image closer to a realistic surface image of the physical product.

The second synthetic training data samples may also be referred to optimized synthetic training data. In this way, the large synthetic dataset retains its composition and balance while the style is modified towards a more realistic appearance. The result will be indistinguishable to both a discrimination model and a human.

According to an embodiment of the present disclosure, the image-to-image translation model comprises an image-to-image generative adversarial network.

According to an embodiment of the present disclosure, the property comprises one or more of:
an annotation usable for classifying a plant disease in an image of a plant;
an annotation usable for classifying cathode active material particles in an image of a battery material;
an annotation usable for classifying cells in an image of a biological material;
an annotation usable for classifying insects on a leaf; and
an annotation usable for classifying defects in a coating.

According to an embodiment of the present disclosure, the property value comprises one or more of:
a property value indicative of a plant damage; and
a property value indicative of a deviation from a standard for an industrial product.

According to an embodiment of the present disclosure, the property value is provided as a damage percentage, which is preferably usable to determine an amount of treatment to be applied to the physical product.

According to an embodiment of the present disclosure, the method further comprises a step of providing a user interface allowing a user to provide the image data.

This will be explained hereinafter and in particular with respect to the example shown in FIG. 2. An exemplary user interface is shown in FIGS. 4A and 4B.

According to an embodiment of the present invention, step c) further comprises providing the label for one or more first synthetic training data samples in the plurality of first synthetic training data samples.

As an example, an annotation file is provided that comprises the label. For example, the annotation file may include the JSON-based file, e.g. COCO (Common Objects in Context) format. The annotation file may be provided by a user or retrieved from a database.

In a second aspect of the present disclosure, a computer-implemented method for analysing a surface image of a physical product, the method comprising:
providing a surface image of the physical product; and
providing a data-driven model to identify at least one object on the provided surface image of the physical product and to generate a label usable for annotating the at least one detected object, wherein the label comprises a property that describes the at least one object on the provided surface image of the physical product and a property value indicative of a damage status of the at least one object on the provided surface image of the physical product, wherein the label is preferably usable for monitoring and/or controlling a production process of the physical product,
wherein the data-driven model has been trained on a training dataset that comprises synthetic training data generated according to the first aspect and any associated example.

This will be explained in detail hereinafter and in particular with respect to the example shown in FIG. 16.

In a third aspect of the present disclosure, a method is provided for controlling a production process of a physical product, the method comprising:
providing a surface image of the physical product;
providing a data-driven model to identify the at least one object on the provided surface image of the physical product and to generate a label usable for annotating the least one object; wherein the label comprises a property that describes the at least one object on the provided surface image of the physical product and a property value indicative of a damage status of the at least one object on the provided surface image of the physical product, wherein the data-driven model has been trained on a training dataset that comprises synthetic training data generated according to the first aspect and any associated example; and
generating, based on the generated label, control data that comprises instructions for controlling an object modifier to perform an operation to act on the at least one detected object.

In an embodiment, object modifier may include any device being configured to perform a measure to modify the object.

In the case of agricultural field, the object modifier may be a plant treatment device that is configured to apply a crop protection product onto an agricultural field. The plant treatment device may be configured to traverse the agricultural field. The plant treatment device may be a ground or an air vehicle, e.g. a tractor-mounted vehicle, a self-propelled sprayer, a rail vehicle, a robot, an aircraft, an unmanned aerial vehicle (UAV), a drone, or the like.

In the case of production environment, the types of object modifier may be dependent on the application scenario. For example, for particles on the conveyor belt, the object modifier may be an air blower that is capable of removing the defective particles from the conveyor belt.

This will be explained hereinafter and in particular with respect to the example shown in FIG. 16.

In a fourth aspect of the present application, a synthetic training data generating apparatus is provided for generating synthetic training data that is usable for training a data-driven model for analysing a surface image of a physical product that comprises at least one object, the synthetic training data generating apparatus comprising one or more processors configured to perform the steps of the method of the first aspect and any associated example.

This will be explained in detail hereinafter and in particular with respect to the examples shown in FIGS. 1 and 2.

In a fifth aspect of the present disclosure, an image analysing apparatus for analysing a surface image of a physical product, the synthetic training data generating apparatus comprising one or more processors configured to perform the steps of the method of the second aspect.

This will be explained in detail hereinafter and in particular with respect to the example shown in FIG. 2.

In a sixth aspect of the present disclosure, a system is provided for controlling a production process of a physical product, the system comprising:
a camera configured to capture a surface image of the physical product;
an apparatus according to the fifth aspect configured to identifying the at least one object on the captured surface image of the physical product and to generate a label usable for annotating the at least one detected object; and
an object modifier configured to perform, based on the generated label, an operation to act on the at least one detected object.

This will be described hereinafter and in particular with respect to the examples shown in FIGS. 17 and 18.

In a further aspect of the present disclosure, a computer program product is provided that comprises instructions which, when the program is executed by a processing unit, cause the processing unit to carry out the steps of the method of the first aspect or the method of the second aspect.

In an embodiment, image or image data may include any data or electromagnetic radiant imagery that may be obtained or generated by one camera, one image sensor, a plurality of cameras or a plurality of image sensors. Image data are not limited to the visible spectral range and to two dimensionalities. Examples of the image may include, but are not limited to, grayscale images, near infrared (NIR) images, RGB images, multispectral images, and hyperspectral images. The frame rate of the camera may be in the range of 0.3 Hz to 48 Hz, but is not limited thereto.

In an embodiment, agricultural field may include an agricultural field to be treated. The agricultural field may be any plant or crop cultivation area, such as a farming field, a greenhouse, or the like. A plant may be a crop, a weed, a volunteer plant, a crop from a previous growing season, a beneficial plant or any other plant present on the agricultural field. The agricultural field may be identified through its geographical location or geo-referenced location data. A reference coordinate, a size and/or a shape may be used to further specify the agricultural field.

In an embodiment, damage may comprise any deviation of the property values from standard property values. Examples of the damage may include plant damages and industrial product damages.

In an embodiment, plant damage may comprise any deviation from the normal physiological functioning of a plant which is harmful to a plant, including but not limited to plant diseases (i.e. deviations from the normal physiological functioning of a plant) caused by:
a) fungi (“fungal plant disease”),
b) bacteria (“bacterial plant disease”)
c) viruses (“viral plant disease”),
d) insect feeding damage,
e) plant nutrition deficiencies,
f) heat stress, for example temperature conditions higher than 30° C.,
g) cold stress, for example temperature conditions lower than 10° C.,
h) drought stress,
i) exposure to excessive sun light, for example exposure to sun light causing signs of scorch, sun burn or similar signs of irradiation,
j) acidic or alkaline pH conditions in the soil with pH values lower than pH 5 and/or pH values higher than 9,
k) salt stress, for example soil salinity,
l) pollution with chemicals, for example with heavy metals, and/or
m) fertilizer or crop protection adverse effects, for example herbicide injuries
n) destructive weather conditions, for example hail, frost, damaging wind.

In an embodiment, input unit may include any item or element forming a boundary configured for transferring information. In particular, the input unit may be configured for transferring information onto a computational device, e.g. onto a computer, such as to receive information. The input unit preferably is a separate unit configured for receiving or transferring information onto a computational device, e.g. one or more of: an interface, specifically a web interface and/or a data interface; a keyboard; a terminal; a touchscreen, or any other input device deemed appropriate by the skilled person. More preferably, the input unit comprises or is a data interface configured for transferring or exchanging information as specified herein below.

In an embodiment, output unit may include any item or element forming a boundary configured for transferring information. In particular, the output unit may be configured for transferring information from a computational device, e.g. a computer, such as to send or output information, e.g. onto another device, e.g. a control unit, that controls and/or monitor the production process of the produced composition. The output unit preferably is a separate unit configured for outputting or transferring information from a computational device, e.g. one or more of: an interface, specifically a web interface and/or a data interface; a screen, a printer, or a touchscreen, or any other output device deemed appropriate by the skilled person. More preferably, the output unit comprises or is a data interface configured for transferring or exchanging information as specified herein below.

Preferably, the input unit and the output unit are configured as at least one or at least two separate data interface(s); i.e. preferably, provide a data transfer connection, e.g. a wireless transfer, an internet transfer, Bluetooth, NFC, inductive coupling or the like. As an example, the data transfer connection may be or may comprise at least one port comprising one or more of a network or internet port, a USB-port and a disk drive. The input unit and/or the output unit may also be may be at least one web interface.

In an embodiment, processing unit may include, without limitation, to an arbitrary logic circuitry configured for performing operations of a computer or system, and/or, generally, to a device or unit thereof which is configured for performing calculations or logic operations. The processing unit may comprise at least one processor. In particular, the processing unit may be configured for processing basic instructions that drive the computer or system. As an example, the processing unit may comprise at least one arithmetic logic unit (ALU), at least one floating-point unit (FPU), such as a math coprocessor or a numeric coprocessor, a plurality of registers and a memory, such as a cache memory. In particular, the processing unit may be a multi-core processor. The processing unit may comprise a Central Processing Unit (CPU) and/or one or more Graphics Processing Units (GPUs) and/or one or more Application Specific Integrated Circuits (ASICs) and/or one or more Tensor Processing Units (TPUs) and/or one or more field-programmable gate arrays (FPGAs) or the like. The processing unit may be configured for pre-processing the input data. The pre-processing may comprise at least one filtering process for input data fulfilling at least one quality criterion. For example, the input data may be filtered to remove missing variables.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a block diagram of an exemplary synthetic training data generating apparatus.

FIG. 2 schematically depicts an exemplary computer network environment for implementing embodiments of the present disclosure.

FIG. 3 illustrates a flowchart describing a computer-implemented method for generating synthetic training data.

FIG. 4A illustrates an exemplary user interface for uploading object images.

FIG. 4B illustrates an exemplary user interface for uploading background images.

FIG. 5 shows images of the different levels of data.

FIG. 6 shows the four steps of the pipeline.

FIG. 7 shows the background removal step.

FIG. 8 shows the resulting images of the cGAN.

FIG. 9 illustrates an exemplary implementation of the pasting algorithm.

FIG. 10 illustrates an exemplary implementation of the image-to-image translation with CUT.

FIG. 11 displays the multilayer, patchwise contrastive loss.

FIG. 12 shows domain A and domain B of the image-to-image translation GAN training.

FIG. 13 illustrates an example of generating data on a continuous scale from low assessments to high assessments.

FIG. 14 shows a comparison of the synthetic and their corresponding optimized images.

FIG. 15 illustrates a flowchart describing a computer-implemented method for training a data-driven model.

FIG. 16 illustrates a flowchart describing a method for field management.

FIG. 17 illustrates an exemplary system for field management.

FIG. 18 shows an exemplary system for identifying a damage status of an industrial product.

### DETAILED DESCRIPTION OF EMBODIMENTS

In many industrial settings, labelled data is very expensive and hard to obtain. For example, unmanned aerial vehicles (UAVs), or drones, are in use to monitor agricultural fields from the air. They are a useful tool to collect images of large portions of the field in a good image quality. In order to work with algorithms on images from these drones, labelled data captured from air are required. However, the drone setup and the drone flight itself are expensive and the images are currently manually annotated by field workers. On top, it is not given that the captured data has the required variety and distribution and there is always the risk of human annotation errors. In another example, a camera is in use in industrial manufacturing to monitor a production process. The acquired images may be provided to algorithms for detection of defects and precise localization of defects. However, image data of a defective product may often be difficult to obtain in large quantities and may be very slow and expensive to gather. This may pose a challenge for the training of data-hungry complex non-linear machine learning models.

Towards this end, a computer-implemented method and a synthetic training data generating apparatus are proposed to synthetically generate training data to expand the training dataset of a data-driven model, which may be a model for performing an image task on a surface image of a physical object, such as regression, classification, object detection, and/or object segmentation.

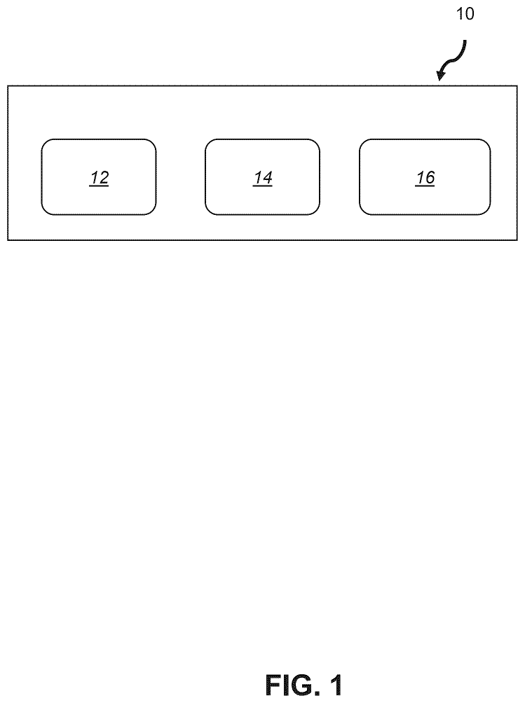

FIG. 1 illustrates a block diagram of an exemplary synthetic training data generating apparatus 10. The synthetic training data generating apparatus 10 comprises an input unit 12, a processing unit 14, and an output unit 16.

In general, the synthetic training data generating apparatus 10 may comprise various physical and/or logical components for communicating and manipulating information, which may be implemented as hardware components (e.g. computing devices, processors, logic devices), executable computer program instructions (e.g. firmware, software) to be executed by various hardware components, or any combination thereof, as desired for a given set of design parameters or performance constraints. Although FIG. 1 may show a limited number of components by way of example, it can be appreciated that a greater or a fewer number of components may be employed for a given implementation.

In some implementations, the synthetic training data generating apparatus 10 may be embodied as, or in, a device or apparatus, such as a server, workstation, or mobile device.

The synthetic training data generating apparatus 10 may comprise one or more microprocessors or computer processors, which execute appropriate software. The processing unit 14 of the synthetic training data generating apparatus 10 may be embodied by one or more of these processors. The software may have been downloaded and/or stored in a corresponding memory, e.g. a volatile memory such as RAM or a non-volatile memory such as flash. The software may comprise instructions configuring the one or more processors to perform the functions described herein.

It is noted that the synthetic training data generating apparatus 10 may be implemented with or without employing a processor, and also may be implemented as a combination of dedicated hardware to perform some functions and a processor (e.g. one or more programmed microprocessors and associated circuitry) to perform other functions. For example, the functional units of the synthetic training data generating apparatus 10, e.g. the input unit 12, the one or more processing units 14, and the output unit 16 may be implemented in the device or apparatus in the form of programmable logic, e.g. as a Field-Programmable Gate Array (FPGA). In general, each functional unit of the synthetic training data generating apparatus may be implemented in the form of a circuit.

In some implementations, the synthetic training data generating apparatus 10 may also be implemented in a distributed manner. For example, some or all units of the synthetic training data generating apparatus 10 may be arranged as separate modules in a distributed architecture and connected in a suitable communication network, such as a 3rd Generation Partnership Project (3GPP) network, a Long Term Evolution (LTE) network, Internet, LAN (Local Area Network), Wireless LAN (Local Area Network), WAN (Wide Area Network), and the like.

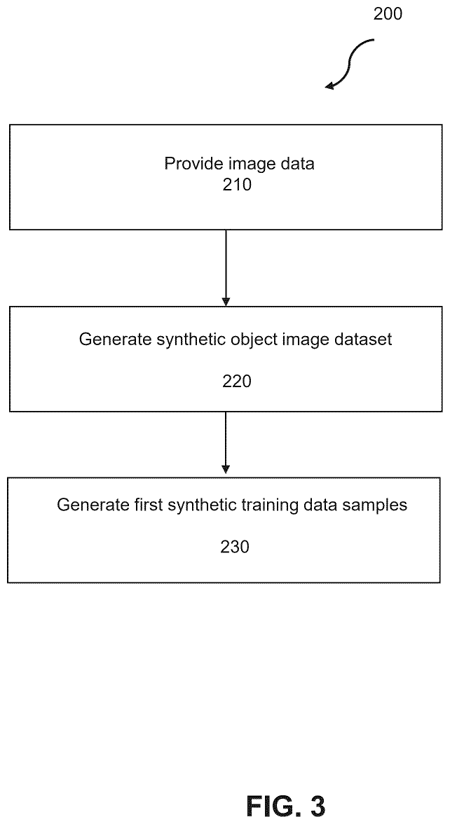

The processing unit(s) 14 may execute instructions to perform the method described herein, which will be explained in detail with respect to the example shown in FIG. 3.

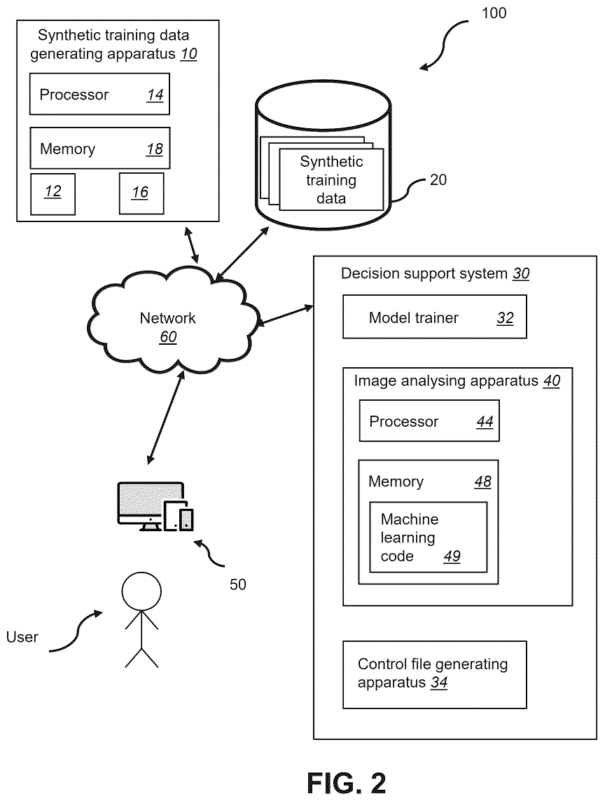

FIG. 2 schematically depicts an exemplary computer network environment 100 for implementing embodiments of the present disclosure. As illustrated, the system 100 includes a synthetic training data generating apparatus 10, a data storage 20, a decision support system 30, one or more electronic communication devices 50, and a network 60.

The synthetic training data generating apparatus 10 may have a similar functionality as the synthetic training data generating apparatus 10 shown in FIG. 1. The exemplary training data generating apparatus 10 of the illustrated example may be a server that provides a web service e.g., to the electronic communication device(s) 50. The exemplary training data generating apparatus 10, as illustrated in FIG. 2, may comprise an input unit 12, one or more processors 14, one or more memory elements 18, an output unit 16, and other components to facilitate or otherwise support generating of synthetic training data. The synthetic training data generating apparatus 10 may provide training data for use during training of a data-driven model.

The data storage 20 is configured to store the training data including the synthetic training data generated by the synthetic training data generating apparatus 10.

The decision-support system 30 may comprise a model trainer 32, an image analysing apparatus 40, and a control file generating apparatus 34.

The model trainer 32 is provided to facilitate or otherwise support training of a data-driven model. Although not shown in FIG. 2, the model trainer 32 may include one or more processors, one or more memory elements, and other components to implement model training logic.

The image analysing apparatus 40 may comprise a processor 44 and a memory 48. The processor 44 may perform a machine learning algorithm (i.e., the data-driven model) by executing code 49 embodying the algorithm. In some examples, the processor 44 may access and execute code for potentially multiple different machine learning algorithms, and may even in some cases, perform multiple algorithms in parallel. The processor 44 may include any processor or processing device, such as a microprocessor, an embedded processor, a digital signal processor (DSP), a network processor, a handheld processor, an application processor, a co-processor, a system on a chip (SOC), or other device to execute code 49. The code 49 embodying a machine learning algorithm may be stored in the memory 48, which may be local or remote to the processor 44. The memory 48 may be implemented as one or more of shared memory, system memory, local processor memory, cache memory, etc., and may be embodied as software, firmware, or a combination of software and firmware.

The control file generating apparatus 34 may be configured to generate a control file based on the result generated by the image analysing apparatus 40. In an embodiment, control file”, also referred to as configuration file, may include any binary file, data, signal, identifier, code, image, or any other machine-readable or machine-detectable element useful for controlling a machine or device.

While a single decision-support system 30 is illustrated in FIG. 2 by way of example, it should be appreciated that the functionality of the decision-support system 30, e.g., the model trainer 32, the image analysing apparatus 40, and the control file generating apparatus 34, may be distributed over multiple servers, which may be clustered, geographically distributed across the network 130, or any combination thereof.

The electronic communication device(s) 50 may act as terminals, graphical display clients, or other networked clients to the synthetic training data generating apparatus 10 and the decision-support system 30. The electronic communication device(s) 50 may comprise an application configured to interface with the web service provided by the synthetic training data generating apparatus 10 and the decision-support system 30. For example, a web browser application at the electronic communication device(s) 50 may support interfacing with a web server application at the synthetic training data generating apparatus 10 and the decision-support system 30. Such a browser may use controls, plug-ins, or applets to support interfacing to the synthetic training data generating apparatus 10 and the decision-support system 30. The electronic communication device(s) 50 may use other customized programs, applications, or modules to interface with the synthetic training data generating apparatus 10 and the decision-support system 30. The electronic communication device(s) 50 may be desktop computers, laptops, handhelds, mobile devices, mobile telephones, servers, terminals, thin-clients, or any other computerized devices.

The network 60 may be any communications network capable of supporting communications between the synthetic training data generating apparatus 10, the decision-support system 30, and the electronic communication device(s) 50. The network 60 may be wired, wireless, optical, radio, packet switched, circuit switched, or any combination thereof. The network 60 may use any topology, and links of the network 60 may support any networking technology, protocol, or bandwidth such as Ethernet, DSL, cable modem, ATM, SONET, MPLS, PSTN, POTS modem, PONS, HFC, satellite, ISDN, WiFi, WiMax, mobile cellular, any combination thereof, or any other data interconnection or networking mechanism. The network 60 may be an intranet, the Internet (or the World Wide Web), a LAN, WAN, MAN, or any other network for interconnecting computers. To support high volume and load, a distributed computing environment may be implemented by using networking technologies that may include, but are not limited to, TCP/IP, RPC, RMI, HHTP, Web Services (XML-RPC, JAX-RPC, SOAP, etc.).

It should be appreciated that, in addition to the illustrated network environment shown in FIG. 2, the synthetic training data generating apparatus 10 and the decision-support system 30 may be combined into a single device. For example, the synthetic training data generating apparatus 10 may be embodied in the decision-support system 30, e.g., as a module.

FIG. 3 illustrates a flowchart describing a computer-implemented method 200 for generating synthetic training data that is usable for training a data-driven model for identifying individual objects in a surface image of a physical product that comprises at least one object. In some examples, the at least one object may comprise only one object. In some examples, the at least one object may comprise a plurality of objects, at least two objects of which are associated with labels that comprise different property values. The computer-implemented method 200 will be described in connection with the system shown in FIG. 2.

At block 210, i.e., step a), the following image data is provided: an object image dataset and a background image. The object image dataset comprises a plurality of object images of the at least one object. At least one object image is associated with a label usable for annotating a content of the object image. In some examples, every object image is associated with a respective label. In some other examples, not every object image needs to be labelled. For example, only the object images, which are to be identified afterwards, must be labelled.

Additional unlabelled object images may make up the picture more natural. The background image represents a background of a surface image of the physical product.

For example, the electronic communication device 50 may comprise a web browser application or other customized programs, applications, or modules configured to interface with the web service provided by the synthetic training data generating apparatus 10. Via the web browser application or other customized programs, applications, or modules, the user may upload several background images (e.g., empty petri-dish plates, leaves, soil, etc.) and images of objects that are separated from their background, e.g. individual spores, insects or eggs, particles using e.g., Username and Password Authentication.

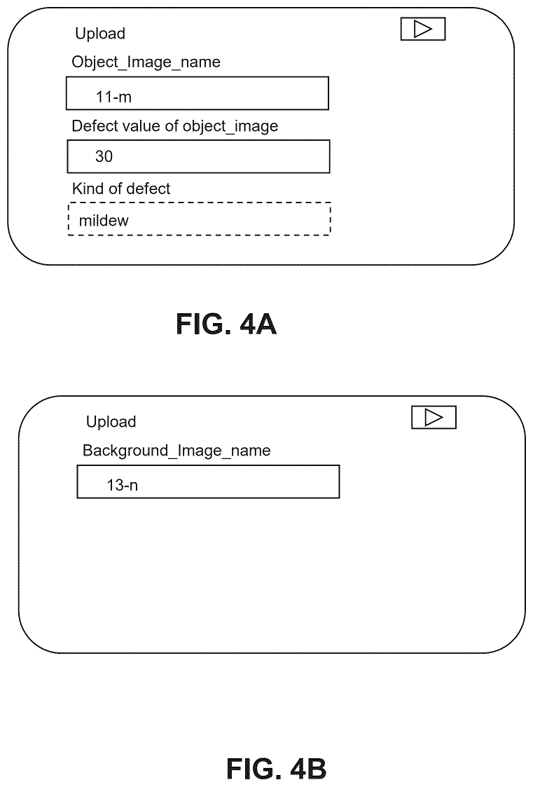

The label comprises a property describing the at least one object. Depending on the application scenario of the data-driven model, the property may comprise one or more of: an annotation usable for classifying a plant disease in an image of a plant, an annotation usable for classifying cathode active material particles in an image of a battery material, an annotation usable for classifying cells in an image of a biological material, an annotation usable for classifying insects on a leaf, and defects in a coating. For example, as shown in FIG. 4A, the annotation may be a class of plant disease, such as a particular form of fungus.

The label also comprises a property value indicative of a damage status of the at least one object. The property values can be numeric values (in form of real numbers), such as percentages or absolute values, or the property values can be classifiers (binary classifiers, indicating the presence or absence of a particular property, multi-class classifiers). In one example, the property value may comprise a property value indicative of a plant damage. In another example, the property value may comprise a property value indicative of a deviation from a standard for an industrial product. In some examples, the property value is provided as a damage percentage, which is preferably usable to determine an amount of treatment to be applied to the physical product. For example, the property value may be a defective value, which may be a score from 0 (healthy) to 100 (diseased) or 0% (healthy) to 100% (diseased) indicative of a plant damage status.

An exemplary user interface of e.g., an online web-based app is shown in FIGS. 4A and 4B. In the examples shown in FIGS. 4A and 4B, the user may provide image data for generating synthetic training data for training a data-driven model for plant damage detection and classification. The user may enter the object image name (e.g., 11-m) in the field “object_image_name” in the user interface shown in FIG. 4A and annotated training values in the field “Defect value of image”. As an example, the defect value of image may be a score from 0 (healthy) to 100 (diseased) indicative of a plant damage status. In the example shown in FIG. 4A, the user assigns a score of 30 to the object image to be uploaded. The user may optionally enter the kind of defect in the field “Kind of defect”, such as a form of fungus “mildew” as shown in FIG. 4B. The user may enter the background image name (e.g., 13-n) in the field “background_image_name” shown in FIG. 4B. It will be appreciated that the layout, number, and order of the facets and the specific names of the facets shown in FIGS. 4A and 4B are presented solely to illustrate the concept. Other layouts, numbers, orders, or names of facets may of course by dynamically displayed.

Turning back to FIG. 3, at block 220, i.e., step b), a synthetic object image dataset is generated from the object image dataset. The synthetic object image dataset comprises a plurality of synthetic object images of the at least one object. At least one synthetic object image being associated with a label. In some examples, every synthetic object image is associated with a respective label. In some other examples, the synthetic object image dataset may comprise unlabelled synthetic object images to generate more realistic images.

This step aims to increase the existing dataset of individual object images. Generative deep learning models, such as Generative Adversarial Networks GAN, Wasserstein GAN, and Non-Adversarial Image Synthesis, may be used to further create new but natural looking variants of the object images.

Since the current dataset of individual object images is labelled and these labels are required in the workflow, the application of the GAN must maintain and replicate this labelling. It would

be possible to use a regular GAN for the extension of the dataset. However, the labels may get lost. Conditional GANs (cGANs) may be a way to overcome this impediment. In addition to input images, labels are fed into the network during training. In this way, the network
learns to generate images for a corresponding label. After the model is trained, it is able to generate a large dataset of object images per class.

At block 230, i.e., step b), a plurality of first synthetic training data samples is generated. Each first synthetic training data sample is generated by selecting one or more object images from the synthetic object image dataset and by plotting the selected one or more object images at one or more locations on the background image.

Using rules and parameters, such as the number of objects in the image, whether objects may overlap or touch, how far or narrow objects should appear, and the like, the actual distribution of the objects in the generated images will be determined. In addition, image augmentation techniques will be employed, to create variations (regarding size, shape, orientation, etc.) of the background and individual classes of object images, so that they reflect the real variability. After setting the parameters, the actual data set generation can be started. The results, natural looking artificial compositions and automatically generated exact label data (e.g., list of coordinates, segmentation masks, etc.) will can be exported in standard formats, which may be used for regression, classification, object detection, and/or object segmentation. Data-driven models can subsequently be directly be and evaluated or manual fine tuning of data-driven models can be performed on the basis of the generated datasets.

In the following, an exemplary implementation of the computer-implemented method 200 is described for generating synthetic training data that is usable for training a data-driven model for analysing a surface image of an agricultural field that comprises at least one plant. In this example, the agricultural field is a lettuce field comprising a plurality of heads of lettuce. Although the lettuce field will be discussed by way of example, it will be appreciated that the computer-implemented method 200 may also be applicable to other agricultural field.

At block 210, image data is provided. The image data comprises an object image dataset comprising a plurality of object images of heads of lettuce. At least one object image is associated with a label usable for annotating a content of the object image. The image data further comprises a background image representing a background of a surface image of the lettuce field.

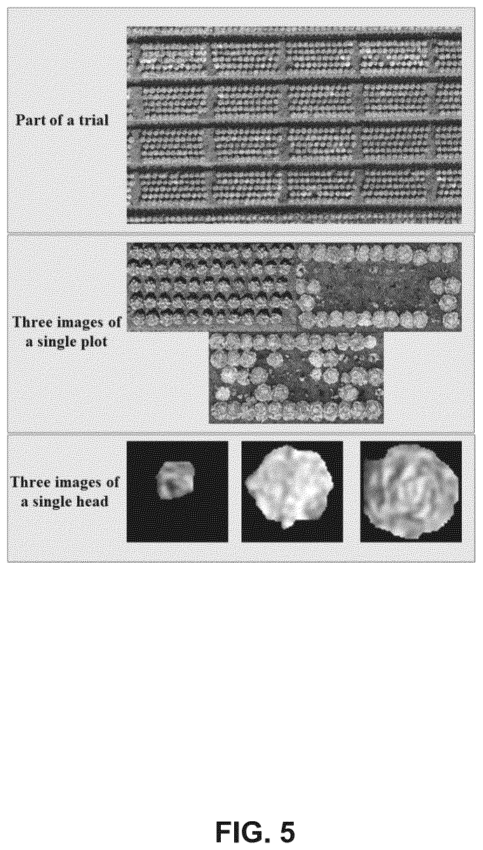

FIG. 5 shows images of the different levels of data. While their composition is later described in detail, a basic understanding is necessary. A field trial on lettuce fields consists of multiple plots. Each plot is a separated part that consists itself of a fixed number of individual heads of lettuce. The label of a plot, which is the target value of the disease prediction algorithms, is the average of the decay (e.g., between 0 (healthy) and 100 (dead) of its single heads. The goal of the workflow is to generate images of plots, so that the generated data can be used to train models.

The workflow starts at the data level of the individual head and ends at the data level of the entire plot. This gradation makes it possible to use the labels of the individual heads, since the labelling of the entire plot is composed of the labels of its individual heads. As the available data for labelled individual heads is of better quality and the data acquisition for labelled individual heads is much easier than for plot images, this approach further reduces the effort and the amount of labelled data in general. This also simplifies the control of the composition of the generated plots, as demonstrated by the workflow in the following.

In a first step, individual heads are extracted from drone images of whole plots. They are then cropped and labelled according to a given assessment. Based on this data, a cGAN is trained, which can then be used to generate a much larger dataset of individual heads. The generated individual heads are then selected from their dataset according to their labelling and placed on a background of soil. This way, the layout of the actual plot images can be replicated, while maintaining both true labelling and an overall balanced data distribution. The final step is to train and apply an image-to-image GAN. This final step allows for the style of the real images to be applied to the synthetically generated plot images, while preserving the structure and given labelling.

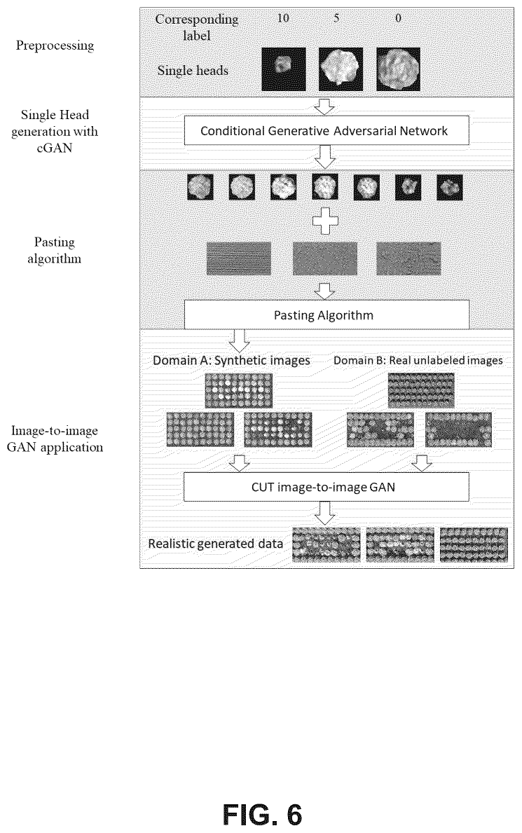

FIG. 6 shows the four steps of the pipeline. After outlining the workflow, the individual steps will now be explained in more detail.

This step of the workflow concerns the data source and processing of the data. As mentioned before, the situation of labelled plot data is insufficient. Therefore, the larger amount of labelled single head images than labelled plot images is used. The individual heads are extracted from the drone plot images.

Due to the height and resolution limitations of drone flights, each head reaches its maximum resolution at 64×64 pixels. The individual head is cropped and saved as a 64×64 pixel PNG file. Since these images will be plotted on a ground background and will be part of a plot formation, the background must be removed from the heads. Each head image is processed using an ImageJ macro. In this process, the head is exposed from the background and treated with erosion. The erosion allows for the individual heads to realistically blend with the background.

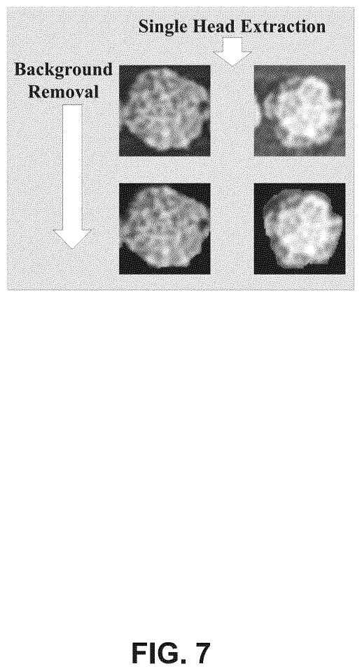

FIG. 7 shows the background removal step. The individual heads were assessed in the field and scored from 0 (healthy) to 100 (diseased). The ratings may be divided into 11 classes (0-10). A total of about 40 images per class could be obtained. This dataset of cropped individual heads is the basis for the following steps of the workflow.

At block 220, a synthetic object image dataset is generated from the object image dataset. The synthetic object image dataset comprises a plurality of synthetic object images of the at least one object.

This step aims to increase the existing dataset of individual heads. GANs have proven to be an effective tool for data augmentation. A larger dataset will be useful later to be able to display more diverse images and not be limited to the availability of only 400 single head images. The description in this subsection is intended to provide an understanding of why a cGAN was used and what its purpose is during the workflow. Both the methodology of the cGAN and the results of testing the quality of the output images are described in later sections.

Since the current dataset of individual heads is labelled and these labels are required in the workflow, the application of the GAN must maintain and replicate this labelling. It would be possible to use a regular GAN for the extension of the dataset. However, the labels would get lost. Conditional GANs are a way to overcome this impediment. In addition to input images, labels are fed into the network during training. This way, the network learns to generate images for a corresponding label.

After the model is trained, it is able to generate a large dataset of images per class. Although there is a minor visual difference between the real images and the images generated by the cGAN, this variety may have influence on the next stages of the workflow. This method enables an increase in the size of those classes that were more difficult to obtain. Since the model learns all classes simultaneously, it is easier for it to achieve a good representation of the otherwise underrepresented classes. For example, it is possible to combine the structural diversity of a class with many samples to the colouration that might be characteristic of another class of heads. With the enlargement of the data set, the data source for the individual lettuce heads is complete and can be used in the next steps.

The cGAN method will be discussed in more detail below.

Data Augmentation Using cGAN

Since the database of individual heads was limited, a GAN method was introduced to complement and extend the existing data. GANs haven proven to serve as a useful tool for data expansion. In this case, it is imperative that the output of the GAN can be controlled because different labels of the heads are needed during the pasting process. This leads to the use of a conditional GAN. cGANs are capable of generating different classes of images, depending on the particular input. For the present case, the manually labelled heads can be divided into 11 classes and used for training with the cGAN.

The open Github repository StudioGAN1 is used as a reference. Several popular GAN architectures have been implemented in it and benchmarks have been performed with three datasets: Cifar10 (3×32×32), TinyImageNet (3×64×64) and ImageNet (3×128×128).

Three factors are critical to the choice of architecture. The performance on TinyImageNet, which corresponds to the input size of the lettuce data approach, the computational cost, and whether the GAN uses labels. Based on these criteria, SAGAN was chosen. After initial training, SAGAN was able to converge fast and capture the properties of the data in visual matching.

Conditional GANs extend the generator and the discriminator by introducing a further input. In addition to the noise or the input image, an auxiliary information Y is included, which for this disclosure is a numeric class label. SAGAN builds on this principle, but provides a more up-to-date and more performant architecture. SAGAN adapts the non-local model and introduces self-attention. This allows both the generator and the discriminator to recognize relationships even between spatially distant parts of the image.

### Training

The model calculates the self-attention between the hidden layers. For this purpose, the image features of each of the previous hidden layers are transformed into two feature spaces f and g to compute attention.

$${\text{?}}_{i , j} = \frac{exp ( s ( i , j ) )}{{\sum }_{i = 1}^{N} exp ( s ( i , j ) )} , where s ( i , j ) = {f ( {x}_{i} )}^{T} g ( {x}_{j} )$$

$$\text{?} \text{indicates text missing or illegible when filed}$$

Here, ß indicates how large the attention of the model is at the ith location when the jth location is considered. The output of the attention layer is o=(o1, o2, o3, . . . , on), where Cis the number of channels and N is the number of feature sorts of the previous hidden layer. The final output of the attention layer is obtained by multiplying by a scalar and adding the input feature map. The scalar causes spatially closer details to be considered first. Thereafter, the model should gradually solve more complex tasks. The generator and discriminator may be trained with the hinge version of Adversarial Loss.

$${L}_{D} = - {𝔼}_{( x , y ) ∼ {p}_{data}} [ min ( 0 , - 1 + D ( x , y ) ) ] - {𝔼}_{( x , y ) ∼ {p}_{data}} [ min ( 0 , - 1 - D ( G ( z ) , y ) ) ] ,$$

$${L}_{G} = - {𝔼}_{( x , \text{?} ) ∼ {p}_{data}} D ( G ( z , y )$$

$$\text{?} \text{indicates text missing or illegible when filed}$$

To stabilize the training, SAGAN uses two additional techniques. First, spectral normalization is applied to both the generator and the discriminator. This approach requires only slightly more computational effort, but has been shown to stabilize the training behaviour. Second, unbalanced learning rates are used for the generator and discriminator updates, which has been shown to produce better results.

Resulting Images of the cGAN

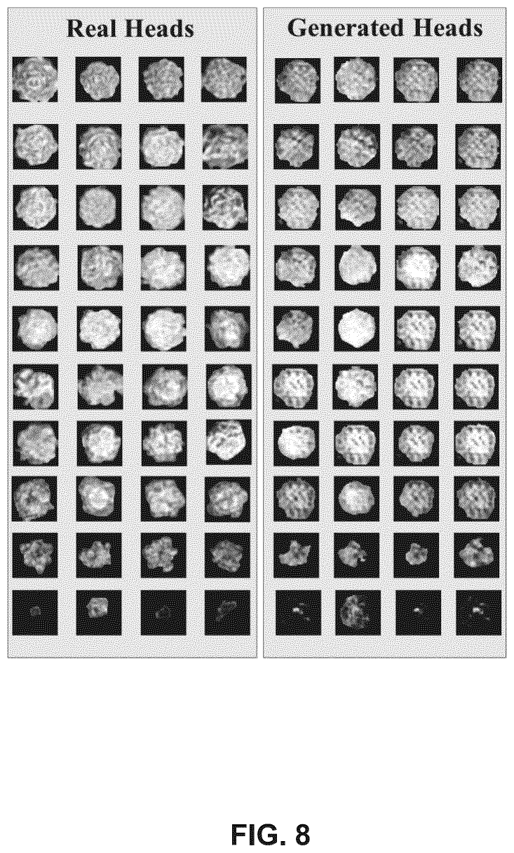

FIG. 8 shows the resulting images of the cGAN. There are minor differences in appearance between the real and the synthetic data. The model was able to replicate the colour and the shape well, but the synthetic heads have a pixelated texture. However, this is consistent with the goal of the cGAN to learn the underlying distribution of the data. A comparison with the real heads shows that there were outliers in the field data whose colour scheme better matched another class. The cGAN is not able to replicate this phenomenon. The samples of each class look homogeneous and different from the samples of the other classes. From healthy to dead, there is a continuum that is visually apparent. Although this was not planned, it is a side effect that proves useful. The generated classes now have a reliable and unique appearance. Also, each of the eleven classes has significantly more samples than the real dataset. Even though there are some heads within the classes that look very similar, overall there is a greater variety of shapes and textures.

At block 230, a plurality of first synthetic training data samples is generated. Each first synthetic training data sample is generated by selecting one or more object images from the synthetic object image dataset and by plotting the selected one or more object images at one or more locations on the background image. In this step, the labels may be separately provided in an annotation file, such as JSON based file, e.g., COCO-format.

The last two steps created and improved the database of individual heads of lettuce. Now these heads are composed to plots. This subsection sets out the relevance and details of this step.

Data from field trials often comes with challenges, notably the small amount and imbalanced distribution of samples. Relying on only the field samples may lead to an overfitted model, resulting in performance losses during test time. In the plots, the occurrence of diseased heads and their arrangement is arbitrary. Since deep learning models are best trained on a balanced training set, there are many opportunities for improvement. Some target values for regression do not even occur in the data and possible compositions that not included in the dataset. The purpose of this step is to provide a foundation to overcome these challenges. To increase variation and balance the training data, this part of the workflow creates a large, well-distributed dataset of plot images. By algorithmically arranging the plots, both the composition of each image and the label can be controlled.

During the algorithmic composing, it is possible to obtain the ground truth label. The target value for the plot fields is defined as the average of all inner individual heads. The outer rows are not affected by the treatment and therefore are not considered. Since the plots consist of a fixed pattern, the algorithm mimics this pattern to obtain a similar appearance to the real images. The step focuses on a realistic pattern and an optimal distribution of the dataset, while the realistic style is applied later on. This method allows for a balanced distribution of data across multiple dimensions. It is possible to have examples for each regression value. When examining compositions that may result in an average value of for instance, 50, it becomes clear that this is possible by having only samples with a value of 50, half of each sample with a value of zero and a value of 100, or any combination between these extremes. Although not every composition occurs in nature, the deep learning model is best trained to the highest possible degree of balance.

In the following the pasting algorithm will be described in detail.

The pasting algorithm composes a dataset of 1000 plot images (SynPlot). Again, while the number could be arbitrarily high, early experiments hinted that there would not be a significant improvement with twice, 5× or 10× the amount of images. The objective of the pasting algorithm is synthesizing a balanced dataset.

Thus, the first task of this step is to draw a sample of a numerical distribution with a certain mean and standard deviation. These two parameters can be used to control both the resulting average and the degree of distribution to achieve that average. Next, a random soil image is selected and the outer row of each lettuce head is plotted with healthy heads. The inner rows are then filled according to the drawn sampling distribution and each head is randomly selected from its class folder. To further increase the variation, the size of the heads and the distances between them are changed with a small random value. This is done to mimic natural irregularities. The modularity of the algorithm was considered in the design of this step. Hence, this workflow can be applied to other data sources as well. In addition, the random parameters controlling, for example, spacing, can be altered. There are also parameters for the number of rows and columns, which would make it possible to apply the workflow to trials with a different layout.

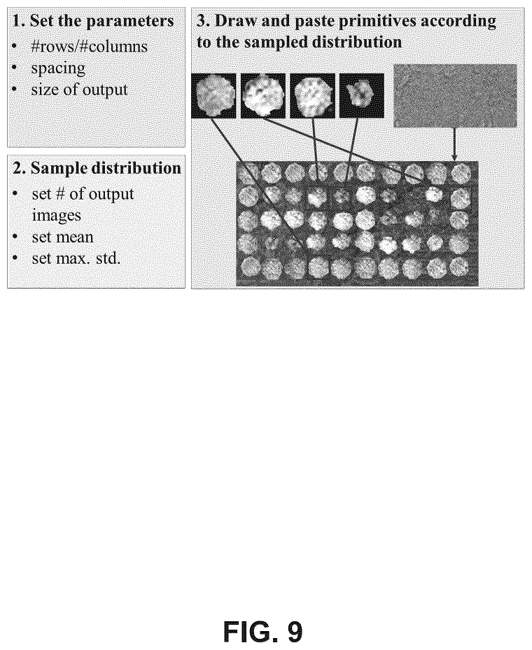

The pasting algorithm may be implemented in Python 3.7. The PIL1 library is used to process the images and a function of the scikit-learn2 Python library is used to generate the random distribution. The parameters that define the layout, the image size and the randomness of spacing and head size are externally set. An exemplary implementation of the pasting algorithm is illustrated in FIG. 9.

Optionally, at block 330, a plurality of second synthetic training data samples may be generated from the plurality of first synthetic training data samples using an image-to-image translation model. The image-to-image translation model has been trained to generate a synthetic surface image closer to a realistic surface image of the physical product.

So far, the workflow has processed and generated individual heads of lettuce and produced a balanced dataset of plot images. However, the images should have an artificial appearance and are significantly different from the field data. This work assumes that visual characteristics such as the blending of the primitive into the background and the overall realism can be improved by the image-to-image translation GAN. This assumption is supported by the fact that image-to-image translation GAN have previously shown to increase the realism of synthetic images.

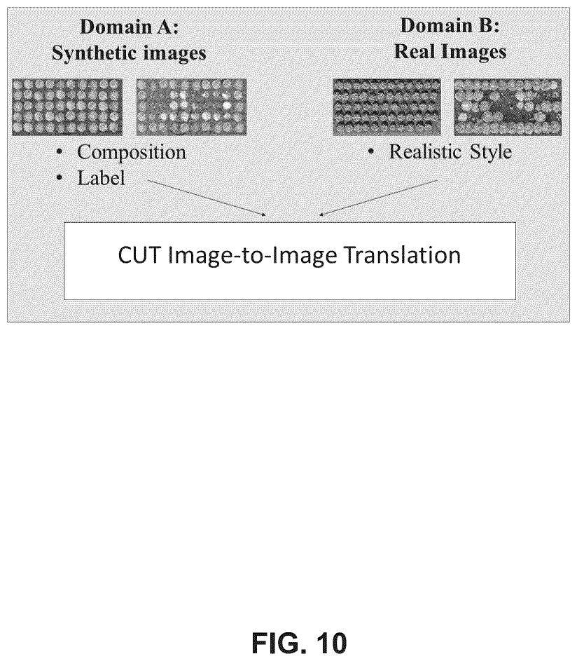

This section describes the role of the image-to-image translation GAN within the workflow, while the functionality and implementation are described later. The CUT model, which is a variant of an image-to-image translation GAN, receives two image domains as an input. Domain A consists of the previously generated images and domain B consists of field data. CUT learns to apply the style of domain B to the images of domain A. This way, the large synthetic dataset retains its composition and balance while the style is modified towards a more realistic appearance. The result will be indistinguishable to both a discrimination model and a human. Because ideally, both the composition of the plot and the degree of decay of each head are maintained, the label remains the same during the application of the trained model. An exemplary implementation of the image-to-image translation with CUT is illustrated in FIG. 10.

In the following the method and the selection of the GAN for image-to-image translation is described.

The principle of image-to-image GAN is comparable to the human ability to transfer styles from one scene to another. For example, it is easy to imagine a landscape at a different season of year, even if one has never seen that specific landscape at that time. Humans are thus able to transfer familiar styles to a particular object. It is precisely this ability that the Image-To-Image GAN mimics. The model is trained on two domains and learns to capture the style and characteristics of one area and transfer them to the other. This assumes, of course, that the two domains have fundamental similarities. For example, the original CycleGAN paper mentions the transfer of seasons to landscapes or the style transfer between horse and zebra. As the two domains in this work are similar and only differ in style, the application of this method is assumed to be possible. The reasoning behind the use of GANs is the underlying objective of the training. It aims at making the outputs indistinguishable from the original images of the domain. When this is achieved, the model has learned weights that transfer an image from domain A to domain B.

### Contrastive Learning

In the selection of a fitting image-to-image GAN architecture, the first and most prominent option is the cycleGAN. However, there is a more recent architecture called Contrastive Unpaired Translation (CUT) that provides better results. The architecture also fits better to this work's challenge as described in the following. CUT introduces an approach that builds on the cycleGAN architecture. The cycle-consistency of cycleGAN requires that the relationship between two domains is a bijection. This is too restrictive, so the authors propose to rather maximize the mutual information between input and output patches. To this end, a contrastive loss function is used that aims to change the appearance of objects while preserving shape and geometry. The method learns mapping in one direction and perform image-to-image translation with a much leaner architecture and therefore more efficiently. The lack of cycle-consistency also allows for one-way image translation with only one image. This offers great potential, especially for scenarios with data scarcity, such as in this work.

### Training

This work includes two domains. Domain A consists of synthetically generated images of plots and domain B consists of actual field images. Due to the unpaired image-to-image transfer, the shape and the basic colour of domain A are preserved. Thus, the labelling of domain A is also preserved. The style, appearance and in some cases the variation of the individual lettuce heads of the plot are transferred from domain B. No labels are necessary for this, since the model learns to recognize regions with high similarity and to transfer the style for these regions accordingly. By matching the patches, such as a patch with a healthy head of lettuce, a corresponding patch with a likewise healthy head of lettuce in the style of domain B is found and taken as a reference. This applies analogously to other parts of the image. To transfer this to

the entire image, as well as for different regions down to the pixel level, a multilayer patch-based learning objective is established. Genc and its feature stack are available to calculate it. Each layer and region of the feature stack represents a region of the input image. Here, deeper layers correspond to larger patches respectively. L layers of interest are selected and fed into a multilayer perceptron H. The number of spatial locations is defined as SL. The corresponding features are defined as zls and the other features as zlS/s. Lastly, yls is the encoded output image. To match corresponding input-output patches, the PatchNCE loss is introduced:

$${L}_{PatchNCE} ( G , H , X ) = {𝔼}_{x ∼ X} {\sum }_{\text{?} = 1}^{\text{?}} {\sum }_{s = 1}^{{S}_{\text{?}}} \text{?} ( {y}_{\text{?}}^{\text{?}} , {z}_{\text{?}}^{\text{?}} , {z}_{\text{?}}^{S / \text{?}} )$$

$$\text{?} \text{indicates text missing or illegible when filed}$$

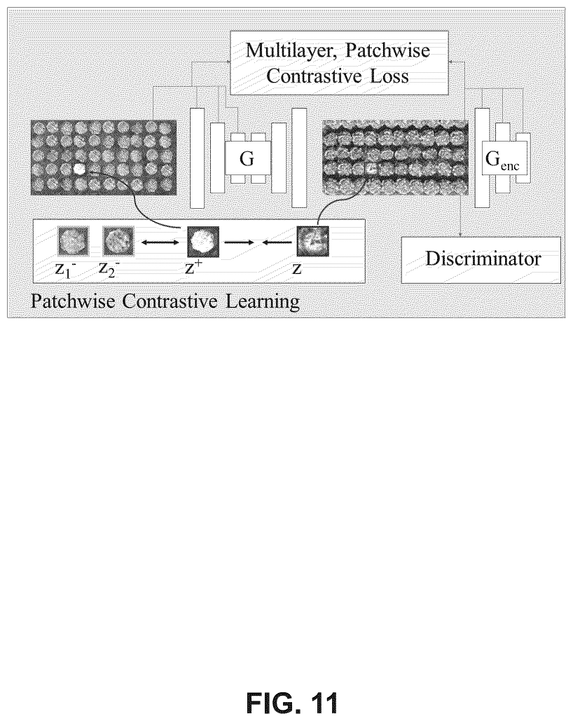

Together with the loss of the GAN, PatchNCE loss contributes to the final objective, which is that the generator should produce realistic images with corresponding input-output patches, while being prevented by the loss from changing too much. FIG. 11 displays the multilayer, patchwise contrastive loss.

### Workflow Images

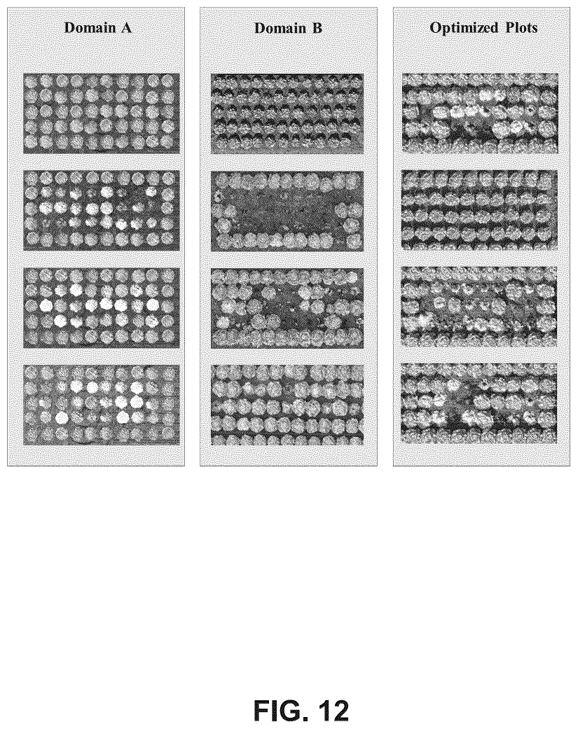

FIG. 12 shows domain A and domain B of the image-to-image translation GAN training. Domain A are the synthesized images from earlier steps of the workflow and domain B consists of real field images. There are differences in appearance between the two domains that make it impossible to train a model on domain A data to predict domain B images. Even though the individual heads are very similar, as the previous experiments have shown, the overall visual appearance has major differences. One of these is the colour composition, since, for example, the sun incidence differs from drone image to drone image. Another major difference is that the insertion algorithm was not able to realistically blend the images with the background. Again, this was not the focus of this work and is therefore not a shortcoming of this step or the workflow as a whole. On the other hand it can also be seen that the appearance of the optimized plots is very similar to the field data. In terms of realism, the optimized images are nearly indistinguishable to the domain B images. However, in terms of colour, the similarity depends on the sample of domain B. Some images are closer than others, depending on lighting and growth state.

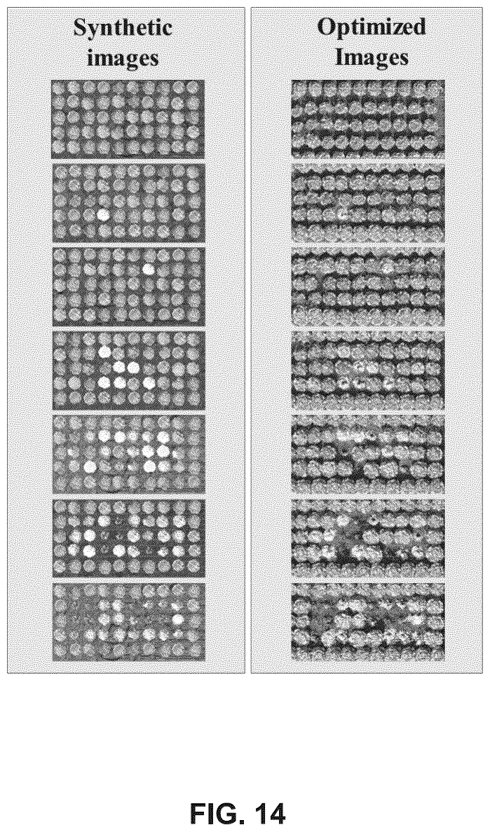

FIG. 14 shows a comparison of the synthetic and their corresponding optimized images. The optimized plots in the right column are the results of the GAN application onto the corresponding image in the left column. The examples demonstrate, that most of the unhealthy heads are translated into unhealthy heads as well. Even though some heads are not translated, the overall composition is kept and the label stays similar. The style of the real plots is successfully transferred. Even the minor variations in head placing are kept to give a more realistic appearance.

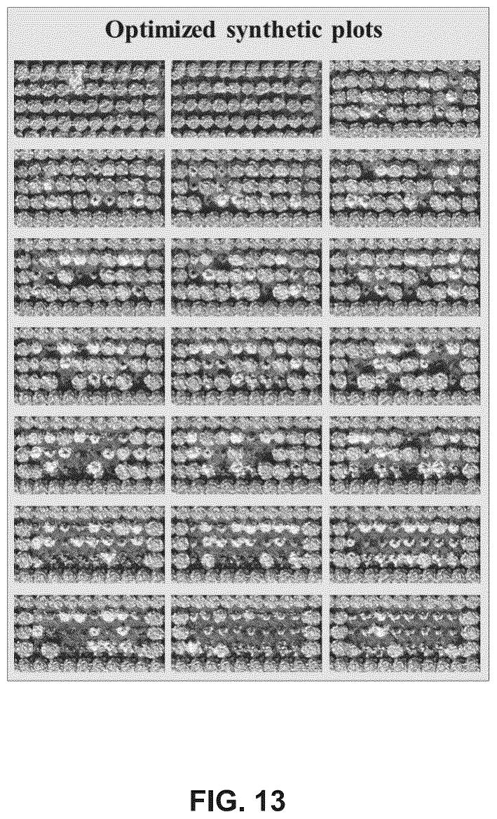

The workflow was not only able to replicate images it has seen before, but also to interpolate the images. To specify, despite the assessment value reaching from 0 to 100, the field data does not contain a sample for each value. Using the workflow, multiple samples per value can be generated. Thus, the workflow is able to generate compositions, that are not contained in the field data and hence, extends the data distribution at hand. It was able to generate data on a continuous scale from low assessments to high assessments, as presented in FIG. 13.

In summary, the individual heads were processed and multiplied by a conditional GAN model.

Then, a balanced dataset of plot images was generated by an insertion algorithm. To make these images utilisable for training, the final step was to apply the style of real field images to the data.

The generated synthetic training data may be stored in a training database, such as the training database in the synthetic training data generating apparatus 10 shown in FIG. 2. The training database may be any organized collection of data, which can be stored and accessed electronically from a computer system and from which data can be inputted or transferred to the decision-support system 30 and the electronic communication device(s) 50 shown in FIG. 2.

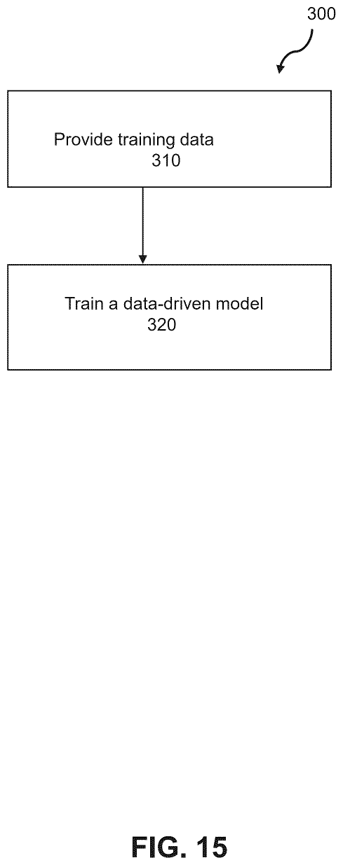

FIG. 15 illustrates a flowchart describing a computer-implemented method 300 for training a data-driven model, which will be described in connection with the system 100 shown in FIG. 2.

At block 310, a training dataset is provided. For example, the model trainer 32 of the decision-support system 30 may retrieve the training data from the training database 20 shown in FIG. 2.

The training dataset comprises synthetic training data generated by the synthetic training data generating apparatus 10. In addition to the synthetic training data, the training dataset may also comprise real images, i.e., images acquired by a camera. The real images do not need to be labelled. In the technical field of agriculture, the real images may be real field data, which may also be from different areas or have different arrangement of crop/weed plant. In this way, less images are needed.

At block 320, a data-driven model is trained on the training dataset. For example, the model trainer 32 shown in FIG. 2 may include one or more processors, one or more memory elements, and other components to implement model to support training of a data-driven model. The data-driven model may be a machine learning algorithm (e.g., embodied in code 49 shown in FIG. 2). The machine learning algorithm may be a deep learning algorithm, such as algorithms based on deep neural networks, convolutional deep neural networks, deep belief networks, recurrent neural networks, etc.

The performance of the data-driven model may be typified by the training of the model or network (e.g., of artificial “neurons”) to adapt the model to operate and return a result in response to a set of one or more inputs. Training may be wholly unsupervised, partially supervised, or supervised.

After training, the resulting data-driven model can be used to perform image tasks, such as object detection (e.g., plant detection, insect detection, etc.), image segmentation, and data augmentation, etc.

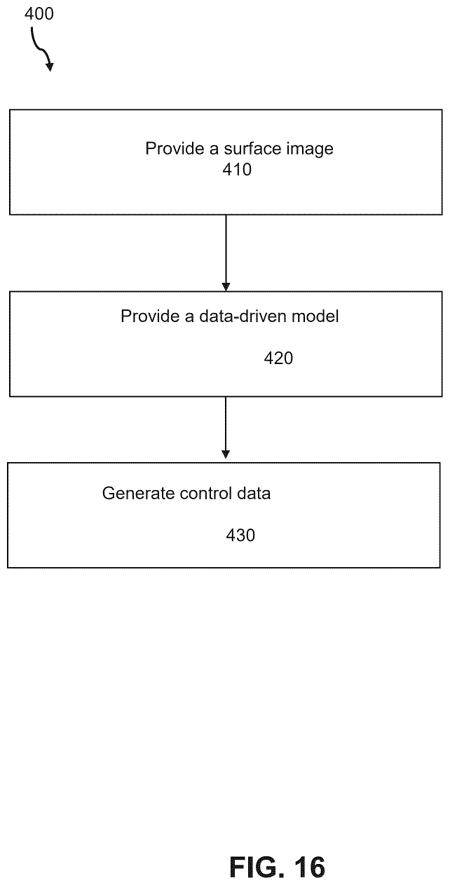

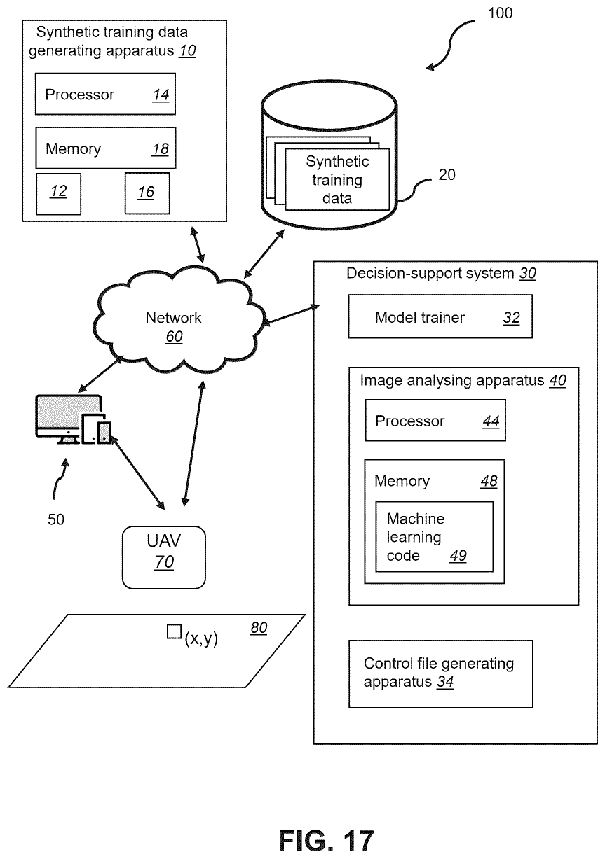

In one example, the data-driven model may be trained to identify a damage status on an agricultural field, which may be usable for field management. This will be discussed with respect to the examples shown in FIGS. 16 and 17.

FIG. 16 illustrates a flowchart describing a method 400 for field management, which will be described in connection with the system 100 shown in FIG. 17. The system 100 shown in FIG. 17 is similar to the system 100 shown in FIG. 2. The difference is that the system 100 in FIG. 16 comprises a trained data-driven model.

In some examples, in the exemplary system shown in FIG. 17, the trained data-driven model may be deployed in the network 60 and no further training is needed in the application in the agricultural field. In some other examples, training may be continuous, such that training continues based on newly generated synthetic training data received from the synthetic training data generating apparatus. Such continuous training may include error correction training or other incremental training (which may be algorithm specific).

Beginning at block 410, a surface image is provided. For example, an image of the agricultural field 100 can be acquired by a camera, which may be mounted on a UAV 70 shown in FIG. 16, aircraft or the like. It possible for the UAV to automatically take the individual images without a user having to control the UAV.

The acquired image is then uploaded to the decision-support system 30. If multiple images are acquired, these images may be provided to the decision-support system 30 for stitching the taken images together. Notably, the individual images can be transmitted immediately after they have been taken or after all images have been taken as a group. In this respect, it is preferred that the UAV 70 comprises a respective communication interface configured to directly or indirectly send the collected images to the decision-support system 30, which could be, e.g. cloud computing solutions, a centralized or decentralized computer system, a computer centre, etc. Preferably, the images are automatically transferred from the UAV 70 to the decision-support system 30, e.g. via an upload centre or a cloud connectivity during collection using an appropriate wireless communication interface, e.g. a mobile interface, long range WLAN etc. Even if it is preferred that the collected images are transferred via a wireless communication interface, it is also possible that the UAV 70 comprises an on-site data transfer interface, e.g. a USB-interface, from which the collected images may be received via a manual transfer and which are then transferred to a respective computer device for further processing.

At block 420, a data-driven model is provided. For example, using the trained data driven model, the image analysing apparatus 40 in the decision-support system 30 may be configured to identify and locate defects in the image, such as based on a score from 0 (healthy) to 100 (diseased) of individual heads of lettuce as described above. For example, the image analysing apparatus 40 may detect damaged plants, e.g., plants damaged by fungi at a point with location (X, Y).

At block 430, the control file generating apparatus 34 of the decision-support system 30 may generate a control file based on identified damaged location. The control file may comprise instructions to move to the identified location and to apply treatment. The identified location may be provided as location data, which may be geolocation data, e.g. GPS coordinates. The control file can, for example, be provided as control commands for the object modifier, which can, for example, be read into a data memory of the object modifier before the treatment of the field, for example, by means of a wireless communication interface, by a USB-interface or the like. In this example, the object modifier may also be referred to as treatment device. In this context, it is preferred that the control file allow a more or less automated treatment of the field, i.e. that, for example, a sprayer automatically dispenses the desired herbicides and/or insecticides at the respective coordinates without the user having to intervene manually. It is particularly preferred that the control file also include control commands for driving off the field. It is to be understood that the present disclosure is not limited to a specific content of the control data, but may comprise any data needed to operate a treatment device.

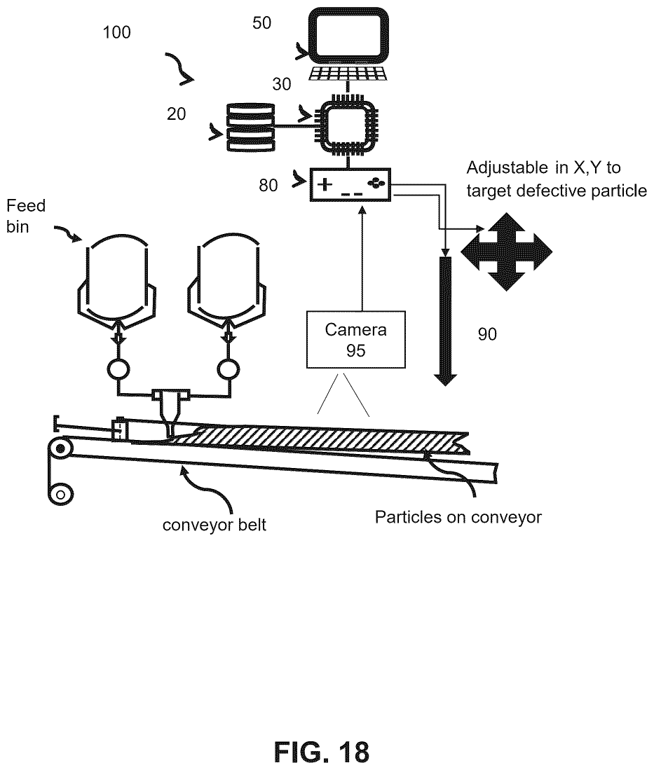

In a further example, the data-driven model may be trained to identify a damage status of an industrial product. This will be discussed with respect to the example shown in FIG. 18.

FIG. 18 shows an exemplary system 500 for identifying a damage status of an industrial product. The system 500 may comprise a data storage 20, a decision-support apparatus 30, an electronic communication device 50, an object modifier 80 with a treatment device 90, and a camera 95.

The decision-support apparatus 30 may be embodied as, or in, a workstation or server. The decision-support 30 may provide a web service e.g., to the electronic communication device 50. The decision-support apparatus 30 may have a similar functionality as the decision-support apparatus shown in FIG. 2. For example, the decision-support apparatus 30 may comprise an image analysing apparatus with a trained data-driven model configured to identify a damage status of an industrial product. The data-driven model may have been trained on a training dataset retrieved from the data storage 20. The training database comprise synthetic training data which has been generated according to the method described herein. An exemplary synthetic training data generating method has been described with respect to the example shown in FIG. 3.

During deployment of the trained data-driven model, the camera 95 can take images from particles on a conveyor belt. The images are provided e.g., to image analysing apparatus 40 (not shown in FIG. 18) in the decision-support system 10. Using the trained data-driven model, the image analysing apparatus 40 is configured to detect damaged location, where it surfaces may show a deviation from normal (or from a standard). The object modifier 80 may receive the location information of the damaged location from the controller, and trigger the treatment device 90 to act on the damaged location of the surface. The operation of treatment device 90 is not limited to a single specific point, its operator can apply measures to substantially all points of the object, with point-specific intensity derived from the location information. For example, as shown in FIG. 18, the system may be used to detect defective particles on the conveyor belt. If it is detected that one or more defective particles at one or more points, the treatment device 90 (e.g., an air blower) which can be controlled by the object modifier 80 to remove the defective particles from the conveyor belt.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above. According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

1. A computer-implemented method for generating synthetic training data that is usable for training a data-driven model for identifying individual objects in a surface image of a physical product that comprises at least one object, the method comprising:
a) providing image data that comprises:
an object image dataset comprising a plurality of object images of the at least one object, at least one object image being associated with a label usable for annotating a content of the object image, wherein the label comprises a property that describes the at least one object in the at least one object image and a property value indicative of a damage status of the at least one object in the at least one object image; and
a background image representing a background of a surface image the physical product;
b) generating a synthetic object image dataset from the object image dataset, wherein the synthetic object image dataset comprises a plurality of synthetic object images of the at least one object, at least one synthetic object image being associated with a label; and
c) generating a plurality of first synthetic training data samples, wherein each first synthetic training data sample is generated by selecting one or more object images from the synthetic object image dataset and by plotting the selected one or more object images at one or more locations on the background image.

2. The computer-implemented method according to claim 1,
wherein the at least one object comprises a plurality of objects, at least two objects of which are associated with labels that comprise different property values.

3. The computer-implemented method according to claim 1,
wherein in step b), the synthetic object image dataset is generated using a generative model.

4. The computer-implemented method according to claim 3,
wherein the generative model comprises a conditional generative adversarial network, cGAN.

5. The computer-implemented method according to claim 1,
wherein in step c) the selected one or more object images are plotted on the background image according to a rule derived from one or more surface image samples of the physical product.

6. The computer-implemented method according to claim 1,
wherein step c) further comprises a step of generating a plurality of second synthetic training data samples from the plurality of first synthetic training data samples using an image-to-image translation model, wherein the image-to-image translation model has been trained to generate a synthetic surface image closer to a realistic surface image of the physical product.

7. The computer-implemented method according to claim 6,
wherein the image-to-image translation model comprises an image-to-image generative adversarial network.

8. The computer-implemented method according to claim 1,
wherein the property comprises one or more of:
an annotation usable for classifying a plant disease in an image of a plant;
an annotation usable for classifying cathode active material particles in an image of a battery material;
an annotation usable for classifying cells in an image of a biological material;
an annotation usable for classifying insects on a leaf; and
an annotation usable for classifying defects in a coating.

9. The computer-implemented method according to claim 1,
wherein the property value comprises one or more of:
a property value indicative of a plant damage; and
a property value indicative of a deviation from a standard for an industrial product.

10. The computer-implemented method according to claim 9,
wherein the property value is provided as a damage percentage, which is preferably usable to determine an amount of treatment to be applied to the physical product.

11. The computer-implemented method according to claim 1, further comprising a step of providing a user interface allowing a user to provide the image data.

12. The computer-implemented method according to claim 1,
wherein step c) further comprises providing the label for one or more first synthetic training data samples in the plurality of first synthetic training data samples.

13. A computer-implemented method for analysing a surface image of a physical product, the method comprising:
providing a surface image of the physical product; and
providing a data-driven model to identify at least one object on the provided surface image of the physical product and to generate a label usable for annotating the at least one detected object, wherein the label comprises a property that describes the at least one object on the provided surface image of the physical product and a property value indicative of a damage status of the at least one object on the provided surface image of the physical product, wherein the label is preferably usable for monitoring and/or controlling a production process of the physical product,
wherein the data-driven model has been trained on a training dataset that comprises synthetic training data generated according to claim 1.

14. A method for controlling a production process of a physical product, the method comprising:
providing a surface image of the physical product;
providing a data-driven model to identify the at least one object on the provided surface image of the physical product and to generate a label usable for annotating the least one object; wherein the label comprises a property that describes the at least one object on the provided surface image of the physical product and a property value indicative of a damage status of the at least one object on the provided surface image of the physical product, wherein the data-driven model has been trained on a training dataset that comprises synthetic training data generated according to claim 1; and
generating, based on the generated label, control data that comprises instructions for controlling an object modifier to perform an operation to act on the at least one detected object.

15. A synthetic training data generating apparatus for generating synthetic training data that is usable for training a data-driven model for analysing a surface image of a physical product that comprises at least one object, the synthetic training data generating apparatus comprising one or more processors configured to perform the steps of the method of claim 1.

16. An image analysing apparatus for analysing a surface image of a physical product, the image analysing apparatus comprising one or more processors configured to perform the steps of the method of claim 13.

17. A system for controlling a production process of a physical product, the system comprising:
a camera configured to capture a surface image of the physical product;
an image analysing apparatus according to claim 16 configured to identifying the at least one object on the captured surface image of the physical product and to generate a label usable for annotating the at least one detected object; and
an object modifier configured to perform, based on the generated label, an operation to act on the at least one detected object.

18. A computer program product comprising instructions which, when the program is executed by a processing unit, cause the processing unit to carry out the steps of the method of claim 1.

19. A computer program product comprising instructions which, when the program is executed by a processing unit, cause the processing unit to carry out the steps of the method of claim 13.
